(19) United States
(12) Patent Application Publication
(10) Pub. No.: US 2007/0193427 A1
(43) Pub. Date: Aug. 23, 2007

(54) Bandsaw blade and cutter tooth arrangement therfor

(75) Inventor: Robert C. Hayden SR., Cape Coral, FL (US)

Correspondence Address: BUCHANAN, INGERSOLL & ROONEY PC, POST OFFICE BOX 1404, ALEXANDRIA, VA, 22313-1404, US

(73) Assignee: KAPMA AB,SWEDEN

(21) Appl. No.: 11/785,568

(22) Filed: Apr. 18, 2007

Related U.S. Application Data
(63) Continuation of application No. 10/831,297, filed on Apr. 26, 2004, now abandoned.
(60) Provisional application No. 60/469,396, filed on May 12, 2003.

(30) Foreign Application Priority Data
Apr. 25, 2003 (EP) 03076236.3

(51) Int. Cl. B27B 13/00

(52) U.S. Cl. 83/788; 83/835

(57) ABSTRACT

A bandsaw blade includes a strip and teeth projecting therefrom, which teeth are arranged in recurring main groups. Each main group comprises recurring geometrical subgroups and recurring setting subgroups. Each geometrical subgroup comprises teeth of at least two different heights, high and low respectively, and comprises an even number of teeth. Each setting subgroup comprises teeth of at least five types, normal left set, medium left set, unset, medium right set and normal right set respectively, and comprises six teeth.

This application claims priority under 35 U.S.C. §119 to Patent Application Serial No. 03076236.3 filed in the European Patent Office on Apr. 25, 2003 and U.S. Provisional Application Ser. No. 60/469,396 filed on May 12, 2003, the entire content of which are incorporated by reference.

### BACKGROUND OF THE INVENTION

The present invention concerns a bandsaw blade comprising a strip and teeth projecting therefrom, which teeth are arranged in recurring main groups, each main group comprising recurring geometrical subgroups and recurring setting subgroups.

### PRIOR ART

Bandsaws have long been used for cutting of hard materials such as metal bars and profiles, their main advantage being that their thickness is less than for circular saws, thus wasting less material. They have disadvantages that have hitherto restricted their use, mainly due to the bandsaw blade loosing its torsional stiffness when the feed force resistance against the tool edge is high. This means that many tooth shapes and arrangements have been suggested with the purpose of reducing the feed force required and other force components that might twist the blade. Such arrangements include having some teeth straight and longer than others to guide the blade laterally, and letting teeth with unequal height and width divide the cut in several thick chips with lesser width, known as the “Triple Chip” geometry.

One way of reducing the effect of the resulting lateral forces on the toothed edge of the sawblade is to let teeth that have large lateral forces occur in pairs with opposite setting. If the distance between them is small enough they will both be in the cut most of the time and their individual lateral forces will counterbalance one another. However, small distances also mean that a larger number of teeth will be cutting simultaneously, with a large resulting feed force when cutting solid sections, which is not desirable, or a small feed force on each tooth, which means inefficient cutting and excessive wear.

Another problem is the low in-plane stiffness for many feed forces acting in unison, with a great risk of vibrations if many teeth at equal distances are cutting, causing vibration, noise, rough surfaces and reduced blade life. The reduced blade life is the result of damage to the tooth edge resulting from vibration. If only a few teeth are cutting simultaneously, the lateral forces will not be counterbalanced, which will result in corrugated surfaces on the workpiece finish. For this reason there has always been a “rule of thumb” that a minimum of three cutting teeth should be in contact with the workpiece.

These problems make it difficult to design an optimal bandsaw even for a well defined task, and even more so if the bandsaw is to be used for a variety of tasks involving different thickness, hardness and shapes of the work pieces. Numerous tooth arrangements have been suggested for such situations. Differences in tooth height have been used not only for lateral guidance, but also to let a few longer teeth do most of the cutting in hard materials while still maintaining a reasonable cutting rate, and have all teeth actively cuffing in soft materials.

Differences in tooth distances are used to avoid vibrations and to locate teeth of equal height in pairs without getting too many cutting at the same time. Differences in setting are used to divide the kerf width into more chips with improved chip formation and greater thickness. Three set widths are traditional, right-unset-left, but five or more also occur, where lower teeth have larger set widths than higher teeth have.

For rational production, the teeth should be arranged in recurrent groups, corresponding to the widths of grinding, milling, punching and setting tools. Very long recurrent groups require larger tools and larger machines which are very expensive or not always available.

Many suggested tooth arrangements, such as those according to U.S. Pat. No. 4,727,788, utilize differences in all three aspects, i.e., variable tooth heights-variable spacing-variable set magnitude; except for a few most are complicated and impractical to manufacture.

The invention according to U.S. Pat. No. 6,269,722 relates to one way of designing teeth for metal bandsaws which is equally useful for hard and soft materials, which causes less vibrations than previous known saws for different materials, and which is still simple to manufacture with high precision. The number of actively cutting teeth is, however, small leading to vibration problems when cutting smaller sections. The cutting performance could also be improved.

Many setting patterns include teeth set to different widths. The concept of variable set levels is not in itself patented but is normally included, in most patents, as part of a specific geometrical and set geometry. Many of these proposed patterns combine different tooth heights, pitches and setting widths with a limited number of teeth in a recurrent main group, the length of which is normally limited by the capacity of tooth forming and or setting equipment. According to the 19th embodiment of what is evident from U.S. Pat. No. 4,727,788 and U.S. Pat. No. 5,410,935 the recurrent group consists of only five teeth. This limits the maximum length of the recurring group to approximately five inches (0.125 m) for very coarse pitch bandsaw blades.

### SUMMARY OF THE INVENTION

A first purpose of the present invention is to create a bandsaw blade with a larger number of cutting teeth per length unit of the blade than has been possible before while still maintaining the ability to cut difficult materials. A second purpose of the present invention is to create a bandsaw blade that shows improved performance in cutting smaller sections with less vibration and increased cutting life in comparison with prior art bandsaw blades. A third purpose of the present invention is to create a bandsaw blade that will give improved surface finish of the work pieces.

The invention thus comprises a bandsaw blade comprising a strip and teeth projecting therefrom, which teeth are arranged in recurring main groups, each main group comprising recurring geometrical subgroups and recurring setting subgroups, each geometrical subgroup comprising teeth of at least two different heights, high and low respectively, and defining a height pattern repeating itself within the group. The high teeth are of substantially equal height, and the low teeth are of substantially equal height which is less than the height of the high teeth. Each geometrical subgroup comprises an even number of teeth, each setting subgroup comprising teeth of at least five types, i.e., normal left set, medium left set, unset, medium right set and normal right set respectively, and defining a setting pattern repeating itself within the group. The normal set teeth are of substantially equal setting and the medium set teeth being of substantially equal setting which is less than the setting of the normal set teeth, each setting subgroup comprising six teeth.

The number of teeth of each geometrical subgroup may not be divisible by six. Each low tooth may be at least 0.1 mm lower than any high tooth before setting. The setting of each one of the medium set teeth may be 40-60% of the setting of each one of the normal set teeth.

The first tooth in each geometrical subgroup may be a high tooth. Every other tooth in each geometrical subgroup may be a high tooth. The second tooth and every other tooth in each geometrical subgroup may be a low tooth. The first tooth in the main recurring group may be the first tooth in the first recurring geometrical subgroup and the first tooth in the first recurring setting subgroup.

The first tooth in each setting subgroup may be an unset tooth. The first tooth and every third tooth after that in each setting subgroup may be an unset tooth. The second tooth and every third tooth after that in each setting subgroup may be a tooth which is set to the left. The third tooth and every third tooth after that in each setting subgroup may be a tooth which is set to the right. The fifth tooth and every sixth tooth after that in each setting subgroup may be a tooth which is medium left set. The third tooth and every sixth tooth after that in each setting subgroup may be a tooth which is medium right set. The second tooth and every sixth tooth after that in each setting subgroup may be a tooth which is normal left set. The sixth tooth and every sixth tooth after that in each setting subgroup may be a tooth which is normal right set. The direction of all set teeth may be reversed, left becomes right and right becomes left.

### BRIEF DESCRIPTION OF THE DRAWINGS

The objects and advantages of the invention will become apparent from the following detailed description of preferred embodiments thereof in connection with the accompanying drawings in which like numerals designate like elements and in which:

FIG. 1 shows, in a side view, a main part of a bandsaw blade according to the invention, the main part comprising a recurring main group of teeth.

FIG. 2 shows, in a top view, a subpart of the main part of the bandsaw blade according to FIG. 1, the subpart comprising a recurring setting subgroup of teeth.

FIG. 3 shows, in a schematic cross section, a part of a prior art bandsaw blade with its set configuration.

FIG. 4 shows, in a schematic cross section, the subpart according to FIG. 2 with its set configuration.

### DETAILED DESCRIPTION OF PREFERRED EMBODIMENTS OF THE INVENTION

The first operation in the manufacture of bandsaw teeth is cutting the teeth in the edge of a steel strip by grinding, milling or blanking. The teeth can have different heights and different pitch distances, i.e. different geometrical appearances from the variable spacing between teeth. According to the present invention, differences in height are necessary, different tooth pitches are conducive to achieving optimum benefit of the invention. If the steel strip is made of two alloys, as is commonly the case, the teeth or the tips of the teeth will be made of high-speed steel, while the body or backing of the blade is made of hardened fatigue resistant material. In many cases, however, tungsten carbide tips are welded or soldered onto the tooth tips, to get even higher abrasion resistance. The teeth are then set by knocking them to either side, except for the ones that are to remain unset.

According to this invention, recurrent main group is achieved by combining a subgroup for height and pitch, i.e. a geometrical subgroup, with a short subgroup for setting as provided for in U.S. Pat. No. 6,269,722. It is important to the invention that the geometrical subgroup is of variable pitches and not of straight pitches. A straight pitch blade will only have a recurrent group length equal to the setting subgroup length, six teeth, which would negate one of the prime advantages of this invention. The geometrical subgroup should not contain an even number of teeth divisible by six or the maximum recurrent group length is only equal to the geometrical subgroup length.

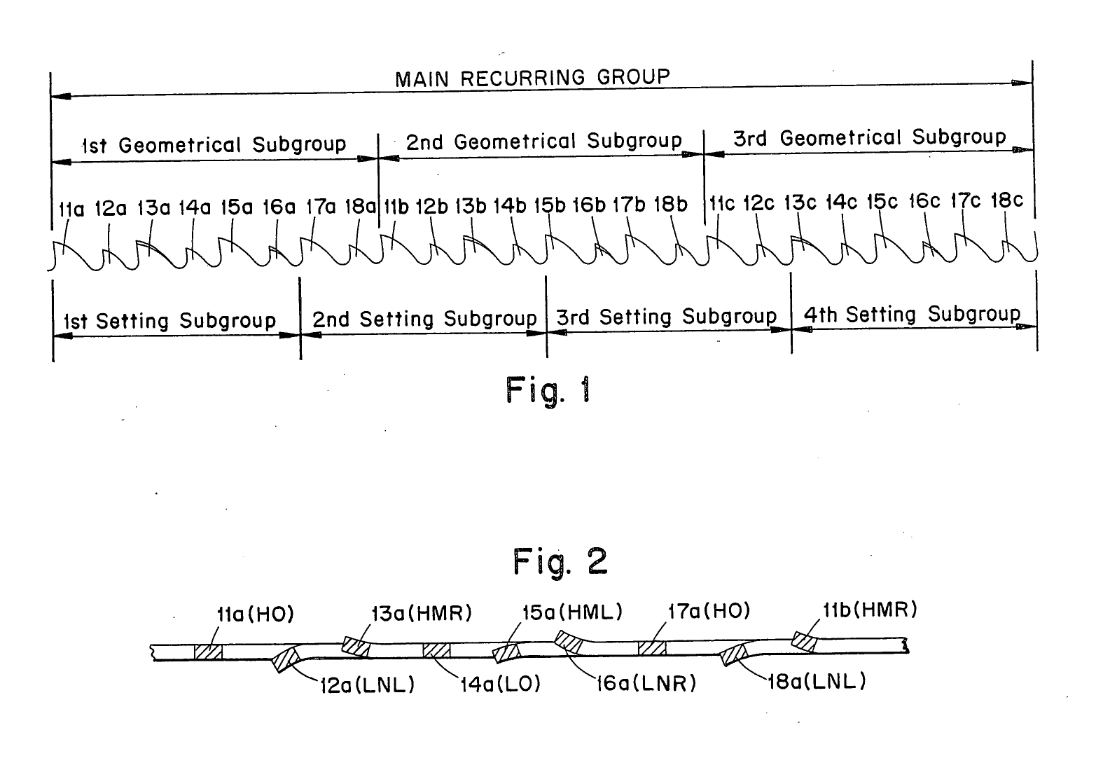

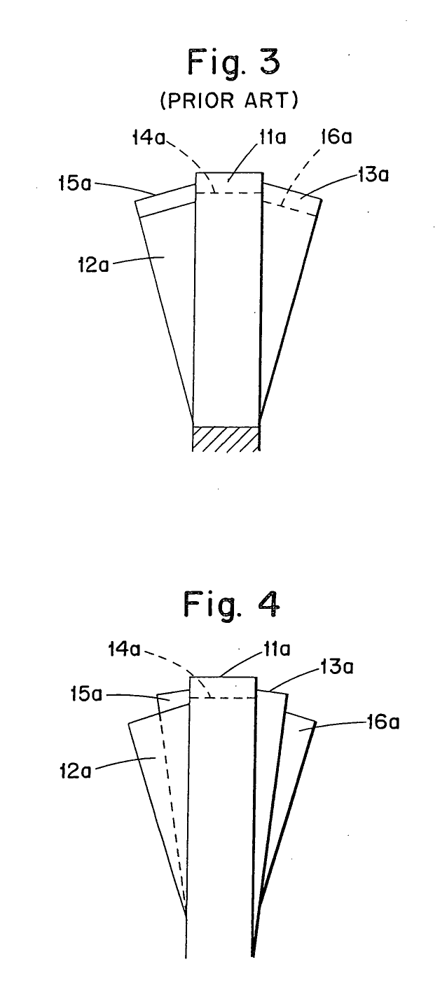

FIG. 1 shows a part of a bandsaw blade 1 according to the invention with a recurrent geometrical subgroup of eight teeth 11a-18a of two different heights, high (H) and low (L) respectively with different pitches. The geometrical subgroup is combined with a short recurrent subgroup of six teeth 11a-16a of five setting types, normal left set (NL), medium left set (ML), unset (O), medium right set (MR) and normal right set (NR) respectively, see FIGS. 2 and 4. As is common with saw blades for metal, prior to setting, the front rake face of every tooth is normal to the band sides. The first tooth 11a is high and unset, the second tooth 12a is low and set normal left, the third tooth 13a is high and medium set right, the fourth tooth 14a is low and unset, the fifth tooth 15a is high and set medium left, the sixth tooth 16a is low and set normal right. No two teeth in this group of six (HO-LNL-HMR-LO-HML-LNR) have the same combination of height and setting, and each of the six possible combinations occurs once.

The second setting subgroup starts with the seventh tooth 17a and is, once again, high and unset and the eight tooth 18a is, once again, low and set normal left. This second setting subgroup compromises teeth 17a-14b with the (HO-LNL-HMR-LO-HML-LNR) setting pattern. The third setting subgroup comprises teeth 15b-12c and the fourth setting subgroup comprises teeth 13c-18c. These three geometrical and four setting subgroups constitute the main recurrent group that is 24 teeth in length. If the geometrical subgroup comprised 10 teeth the main recurrent group would be 30 teeth in length. It is desirable that the geometrical subgroup contains as many teeth as possible, providing it conforms to the even number of teeth not divisible by six requirement. The only limit to the length of the subgroup being the size limitation of the toothing equipment. For example if the length of the geometrical subgroup is 4 inches (0.1 m) and the tooth pitch pattern is ⅔ variable pitch, i.e. the tooth spacing varies between 0.5 and 0.333 inches (0.0125 and 0.0083 m), it would most likely contain 10 teeth. The main recurring group would be 12 inches (0.3 m) in length, contain 30 teeth that would be six times the length of a comparable blade described in either of U.S. Pat. No. 4,727,788 or U.S. Pat. No. 5,410,935. This greatly reduces the tendency of the blade to generate repetitive oscillatory vibration patterns.

By the present invention the concept of low teeth being set heavier than high teeth is utilized. Compared to what is evident from U.S. Pat. No. 6,269,722 the number of actively cutting teeth increases from three to five of every six teeth without increasing feed cutting forces and thereby maintaining ability to cut difficult materials. By increasing the cutting teeth from three to five, the performance in cutting smaller sections is greatly improved as more teeth remain in contact with the work piece and forces on individual teeth is reduced. The width of the chips removed by the normal set low tooth and the medium set high tooth are half the width of the chip previously removed by the wide set high tooth, therefore the lateral forces on each tooth is halved and are spread out over more teeth resulting in less lateral vibration and improved surface finish.

Tests were conducted to compare performance of a standard production blade according to U.S. Pat. No. 6,269,722 with that of a modified blade according to the present invention. All blades tested were from the same production run to exclude influences from other parameters. The tests were divided into two separate categories, the first to evaluate the general performance of blades in different materials with large cross sectional areas, the second to evaluate performance when cutting smaller sections known to cause tooth damage. For all test series a standard production blade (Ref A) and a blade with modified set pattern (Ref B), according to invention, were tested. The blades had the following specifications:

| | |
|---|---|
| Product code | 3854 |
| Bandwidth in mm | 41 |
| Band thickness in mm | 1.3 |
| Tooth form by grinding | PHG |
| Variable tooth pitch | ⅔ |
| Band length in mm | 5800 |

Test 1

A total of 12 cuts were made for each blade. The vertical force and noise levels were measured and recorded for every cut. The forces were measured in Newtons and the noise level in decibels. Noise levels correspond to vibration levels in cut.

| | Dimensions | Band Speed | Feed Rate | | Feed Force | | Noise | |
|---|---|---|---|---|---|---|---|---|
| Material | (mm) | (mm/min.) | (mm/min.) | # Cuts | Ref A | Ref B | Ref A | Ref B |
| Hot working | 111 × 190 | 39 | 13 | 2 | 535 | 490 | 97.6 | 93.5 |
| Tool Steel | | | | | | | | |
| Stainless Steel | 107 × 140 | 26 | 9.4 | 2 | 744 | 704 | 109 | 107 |
| SS 2377 | | | | | | | | |
| Ball Bearing | Rd 115 | 65 | 44 | 5 | 725 | 716 | 94.9 | 94 |
| Steel | | | | | | | | |
| 52100 | | | | | | | | |
| Cold Working | 45 × 145 | 30 | 7.6 | 2 | 496 | 483 | 103.4 | 100 |
| Tool Steel | | | | | | | | |

As expected, the cutting forces were very close and the noise levels for the trial blade were noticeably lower, thus verifying the effect of the invention on reducing vibration.

Test 2

A total of 9 cuts were made for each blade. The vertical cutting forces and noise levels were measured and recorded. The work pieces were round and square tubing known to cause chipping and would not be a normal application for the standard Ref A blade.

| | | Blade | | | | | | |
|---|---|---|---|---|---|---|---|---|
| | Dimensions | Speed | Feed Rate | | Feed Force | | Noise | |
| Material | (mm) | (mm/min.) | (mm/min.) | # Cuts | Ref A | Ref B | Ref A | Ref B |
| SS304L | Rd 300 × 27 | 47 | 18 | 3 | 513 | 497 | 88.9 | 87.2 |
| SS316L | Sq 100 × 200 × 10 | 44 | 16 | 3 | 354 | 310 | 91.4 | 89.3 |
| SS316L | Sq 100 × 200 × 10 | 44 | 40 | 3 | 804 | 652 | 93.1 | 90 |

The vertical cutting forces and also the noise levels during the test are generally lower for the Ref B blade, which was set according to the invention. It is clear that the tougher the blade is run the better the performance of the Ref B blade.

The blades were cut into sections and inspected for tooth chipping with a stereomicroscope. The teeth were evaluated from a completely undamaged tooth given the value of 0% to the full chipping of the edge given a value 100%. The results for the two blades is as follows:

Average Chipping Percentage (%)

| | High Teeth | Low Teeth |
|---|---|---|
| Ref A Blade | 88 | 16 |
| Ref B Blade | 51 | 8 |

It is very evident from these results that the chipping damage for the Ref B, modified according to the invention, is 42-50% less than that for the Ref A blade based on prior art. From the results of all the tests it is very clear that the present invention achieved all of its objectives.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. Bandsaw blade comprising a strip and teeth projecting therefrom, the teeth arranged in recurring main groups, each main group comprising recurring geometrical subgroups and recurring setting subgroups, characterized by:
each geometrical subgroup comprising teeth of at least two different heights including high and low, respectively, and defining a height pattern repeating itself within the group, the high teeth being of substantially equal height and the low teeth being of substantially equal height which is less than the height of the high teeth, each geometrical subgroup comprising an even number of teeth, each setting subgroup comprising teeth of at least five types including normal left set, medium left set, unset, medium right set and normal right set, respectively, and defining a setting pattern repeating itself within the group, the normal set teeth being of substantially equal setting and the medium set teeth being of substantially equal setting which is less than the setting of the normal set teeth, each setting subgroup comprising six teeth.

2. Bandsaw blade according to claim 1, where the number of teeth of each geometrical subgroup is not divisible by six.

3. Bandsaw blade according to claim 1, wherein each low tooth is at least 0.1 mm lower than any high tooth before setting.

4. Bandsaw blade according to claim 1, wherein the setting of each one of the medium set teeth is 40-60% of the setting of each one of the normal set teeth.

5. Bandsaw blade according to claim 1, wherein the first tooth in each geometrical subgroup is a high tooth.

6. Bandsaw blade according to claim 1, wherein every other tooth in each geometrical subgroup is a high tooth.

7. Bandsaw blade according to claim 1, wherein the second tooth and every other tooth in each geometrical subgroup is a low tooth.

8. Bandsaw blade according to claim 1, wherein the first tooth in the main recurring group is the first tooth in the first recurring geometrical subgroup and the first tooth in the first recurring setting subgroup.

9. Bandsaw blade according to claim 1, wherein the first tooth in each setting subgroup is an unset tooth.

10. Bandsaw blade according to claim 1, wherein the first tooth and every third tooth after that in each setting subgroup is an unset tooth.

11. Bandsaw blade according to claim 1, wherein the second tooth and every third tooth after that in each setting subgroup is a tooth which is set to the left.

12. Bandsaw blade according to claim 1, wherein the third tooth and every third tooth after that in each setting subgroup is a tooth which is set to the right.

13. Bandsaw blade according to claim 1, wherein the fifth tooth and every sixth tooth after that in each setting subgroup is a tooth which is medium left set.

14. Bandsaw blade according to claim 1, wherein the third tooth and every sixth tooth after that in each setting subgroup is a tooth which is medium right set.

15. Bandsaw blade according to claim 1, wherein the second tooth and every sixth tooth after that in each setting subgroup is a tooth which is normal left set.

16. Bandsaw blade according to claim 1, wherein the sixth tooth and every sixth tooth after that in each setting subgroup is a tooth which is normal right set.

17. Bandsaw blade according to claim 1, wherein the direction of all set teeth are reversed, so that left becomes right and right becomes left.
